(19) United States
(12) Patent Application Publication
(10) Pub. No.: US 2021/0331927 A1
(43) Pub. Date: Oct. 28, 2021

(54) CROSS-LINKED GRAPHENE OXIDE COMPOSITIONS AND APPLICATIONS THEREOF

(71) Applicant: The Board of Trustees of the University of Arkansas, Little Rock, AR (US)

(72) Inventors: Z.R. TIAN, Fayetteville, AR (US); Hulusi TURGOT, Fayetteville, AR (US)

(21) Appl. No.: 16/322,849

(22) PCT Filed: Aug. 3, 2017
(86) PCT No.: PCT/US2017/045303

§ 371 Date: Feb. 1, 2019

Related U.S. Application Data
(60) Provisional application No. 62/371,084, filed on Aug. 4, 2016.

(51) Int. Cl. C01B 32/198

(52) U.S. Cl. CPC C01B 32/198; C01P 2004/20; B82Y 30/00; C01P 2006/82; C01P 2004/64

(57) ABSTRACT

In one aspect, graphene oxide compositions are described herein. Briefly, a graphene oxide composition comprises sheets of graphene oxide cross-linked with one another via metal cations in an oxidation state of at least 3⁺. As described further herein, faces and/or edges of the graphene oxide sheets can be cross-linked by the metal cations. In some embodiments, metal cations are covalently bonded to faces and/or edges of the graphene oxide sheets.

### CROSS REFERENCE TO RELATED APPLICATIONS

This application claims priority pursuant to 35 U.S.C. § 119(e) to U.S. Provisional Patent Application Ser. No. 62/371,084 filed on Aug. 4, 2016, which is hereby incorporated by reference in its entirety.

### STATEMENT OF GOVERNMENT RIGHTS

The present invention was made with government support under National Science Foundation (EPSCoR) Grant Number EPS1003970. The United States Government has certain rights to the present invention.

### FIELD

The present invention relates to graphene oxide compositions and, in particular, to cross-linked sheets of graphene oxide.

### BACKGROUND

For a decade, graphene-based materials have been attracting enormous attention due to their superior mechanical and electrical properties on top of highly accessible specific surface area. In search for better and cheaper routes to synthesizing these materials, chemical modification of graphene oxide (GO) is considered the most easily scalable to date. However, on the GO-surface, energetic epoxide groups were recently found to render GO highly flammable, and inorganic by-products including potassium and sodium salts (i.e. the residue from the GO synthesis) were found to contribute significantly to the violent combustability of the GO in ambient air. This fire-hazard renders GO a potentially hazardous material, including the partially reduced GO (or rGO), especially in their dry-form of any type. Therefore, new GO structures and associated fabrication methods are called for.

### SUMMARY

In one aspect, graphene oxide compositions are described herein. Briefly, a graphene oxide composition comprises sheets of graphene oxide cross-linked with one another via metal cations in an oxidation state of at least 3⁺. As described further herein, faces and/or edges of the graphene oxide sheets can be cross-linked by the metal cations in an oxidation state of at least 3⁺. In some embodiments, such metal cations are covalently bonded to faces and/or edges of the graphene oxide sheets. Any cations of oxidation state 3⁺ or higher not inconsistent with the objectives of the present invention can be used to cross-link graphene oxide sheets. For example, aluminum cations (Al³⁺) can be employed for cross-linking of graphene oxide sheets.

In other embodiments, one or more transition metal cations and/or rare earth cations in an oxidation state of at least 3⁺ can cross-link graphene oxide sheets. In some embodiments, transition metal cations of Groups IVB to VIIIB of the Periodic Table can cross-link graphene oxide sheets, the metal cations in an oxidation state of at least 3⁺. Transition metal cations, in some embodiments, are in an oxidation state of 4⁺ to 6⁺ such as Mn⁴⁺, V⁵⁺ and/or Mo⁶⁺. Moreover, the cross-linked graphene-oxide sheets can be stable under ambient atmospheric conditions. In further embodiments, the cross-linked graphene sheets are inflammable under ambient atmospheric conditions and/or upon exposure to an open flame. The cross-linked graphene sheets can form freestanding or self-supporting films, membranes or layers.

In another aspect, composite compositions employing graphene oxide films are described herein. In some embodiments, a composite composition includes a substrate and a graphene oxide film positioned over the substrate, the graphene oxide film comprising sheets of graphene oxide cross-linked with one another via metal cations in an oxidation state of at least 3⁺. The graphene-oxide films can exhibit desirable characteristics including stability under ambient and high temperature conditions as well as resistance to flammability. Therefore, such composite compositions can find application in a variety of high temperature (above 120° C.) applications including, but not limited to, fuel cells, electronics and coatings. Substrate identity can be chosen according to desired application of the composite material. In some embodiments, substrates for graphene oxide films described herein comprise polymeric materials such as polystyrene, polyethylene terephthalate, fluoropolymer, polyolefin, polyamide, waxes or various combinations thereof. In other embodiments, substrates can be formed of metal, metal oxide, ceramic or combinations thereof. Graphene oxide films can be deposited directly on substrate surfaces. One or more layers, such as adhesion layers or other functional layers, can be positioned between the graphene oxide film and substrate surface.

In another aspect, methods of making graphene oxide compositions are described herein. A method of making a graphene oxide composition comprises providing a mixture of graphene oxide sheets and metal cations in a polar continuous phase and cross-linking the graphene oxide sheets with the metal cations, wherein the metal cations are in an oxidation state of at least 3⁺. Faces and/or edges of the graphene oxide sheets can be cross-linked with the trivalent metal cations. In some embodiments, one or more metal cations are covalently bonded to the graphene oxide sheets. The polar continuous phase, in some embodiments, can be water or aqueous-based solvent. Moreover, the metal cations can be provided as a salt. In some embodiments, for example, trivalent metal cation is Al³⁺X, wherein X comprises one or more counter-ionic species.

These and other embodiments are described in further detail in the following detailed description.

### BRIEF DESCRIPTION OF THE DRAWINGS

FIGS. 1(a)-(c) illustrate a synthetic method for cross-linking sheets of graphene oxide according to some embodiments described herein.

FIG. 2(a) illustrates combustion of a prior GO film in response to an applied flame.

FIG. 2(b) illustrates flammability resistance of a cross-linked GO (cl-GO) film described herein in response to an open flame.

FIG. 3(a) illustrates thermo-gravimetric (TGA) data for GO and cross-linked GO according to one embodiment described herein.

FIG. 3(b) illustrates differential scanning calorimetry (DSC) results for GO and cross-linked GO according to one embodiment described herein.

FIGS. 4(a) and 4(b) illustrate elemental analysis of GO and cross-linked GO films respectively.

FIG. 5(a) is a transmission electron microscopy (TEM) image of a GO sheet.

FIGS. 5(b)-(d) are TEM images of cross-linked GO sheets according to some embodiments described herein.

FIG. 6(a) provides Fourier-transform infrared (FT-IR) spectra of GO sheets and cross-linked GO sheets according to some embodiments described herein.

FIG. 6(b) provides X-ray diffraction spectra of GO sheets and cross-linked GO sheets according to some embodiments described herein.

FIGS. 6(c)-(d) are de-convoluted X-ray photoelectron spectra of GO sheets and cross-linked GO sheets according to some embodiments described herein.

FIG. 7 illustrates micro-Raman spectra for GO sheets and cross-linked GO sheets according to some embodiments.

FIGS. 8(a) and 8(b) illustrate the structure of GO and cross-linked GO respectively according to some embodiments described herein.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

Cross-linked graphene oxide compositions and associated methods are described herein with reference to the following non-limiting embodiment wherein trivalent aluminum cations (Al³⁺) are employed as the cross-linking agent. It is contemplated that other metal cationic species may be employed in other embodiments for cross-linking graphene oxide sheets.

Herein, a new synthetic method is also reported for mass-producing non-flammable GO, by cross-linking the GO with Al³⁺ cations in one-step in aqueous solutions at room-temperature. The cross-linked GO (cl-GO) resists the combustion in ambient air on open-flame, and shows in addition a greatly improved thermal stability. This thermally stable cl-GO can be applicable to making devices operational at elevated temperatures (above 120° C.) even in air, such as fuel cells, high-temperature coating, electronic packaging, to name a few. Characterization data further suggest that the cross-linked GO inherited all characteristics of ordinary GO but without the flammability hazard, and its good dispersibility in water can make it widely fine-tunable further, which greatly expands the new cl-GO's processibility and, in turn, its wide applicability on the industrial scale.

It was detailed in the literature that even air-drying near 100° C. can trigger a thermal reduction-decomposition of GO, which is potentially dangerous in large-scale manufacturing. This is because such a decomposition of GO is as highly exothermic and almost self-igniting that must be absolutely avoided in any large-scale manufacturing. Moreover, literature indicates that residual potassium salts in GO, from the GO-synthesis involving KMnO₄ or K₂S₂O₈, can readily transform to various potassium-containing impurities that aid extremely flammable forms of GO. Removing these impurities by employing filtration or dialysis is time-consuming and costly, because GO-flakes easily clog the filter-pores and reduced the water-flow across the filtering media (e.g. anodized aluminum oxide or AAO). Washing with abundant water was found to be troublesome because after a few washing-cycles the GO started to irreversibly gelatinize which drastically increased the time and manpower in the follow-up centrifugal separations. Further, both the filtration and washing still resulted in the GO-flakes with energetic epoxide groups that can render GO to be flammable.

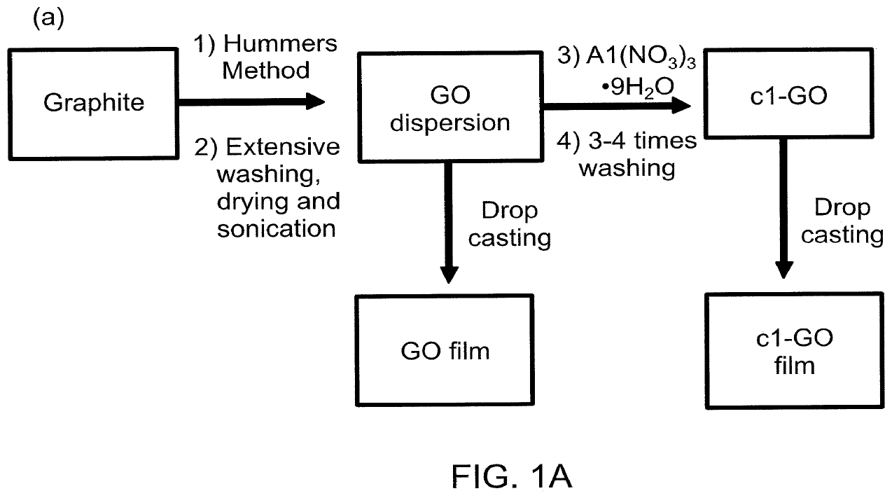

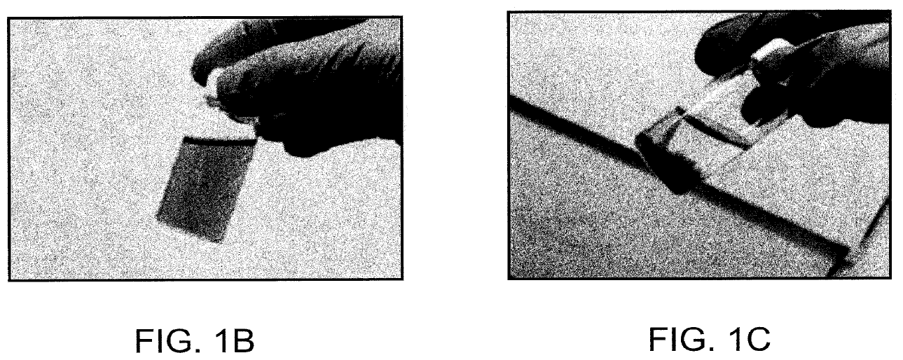

GO-synthesis illustrated in FIGS. 1(a)-(c) was administered via a modified Hummer's method, and the resultant GO was washed with a copious amount of water with centrifugation. The GO material was dried in an oven, and thereafter exfoliated in DI water using an ultra-sonication. The suspension of the exfoliated GO was added into an aqueous solution (1.0% w/w) of Al(NO₃)₃ under a vigorous stirring, in order for the cross-linking to take place instantly at the room-temperature. This cross-linking was followed by a few times of washing with DI water, for further reducing the K-containing impurities' content. FIG. 1(b) illustrates a GO solution (0.5 mg/ml), and FIG. 1(c) illustrates GO being cross-linked after 1 minute in solution (1.0 wt. %) of Al(NO₃)₃. Afterwards, 100 ml of the GO suspension was centrifuged at 4000 rpm for an hour, and the resultant GO precipitate was collected and then drop-cast on a glass-slide surface to dry into a thin flexible freestanding membrane about 15-20 microns thick. The cl-GO membrane, together with another similar-sized GO-film but without the cross-linking, were each exposed to an open-flame from a commercial butane lighter.

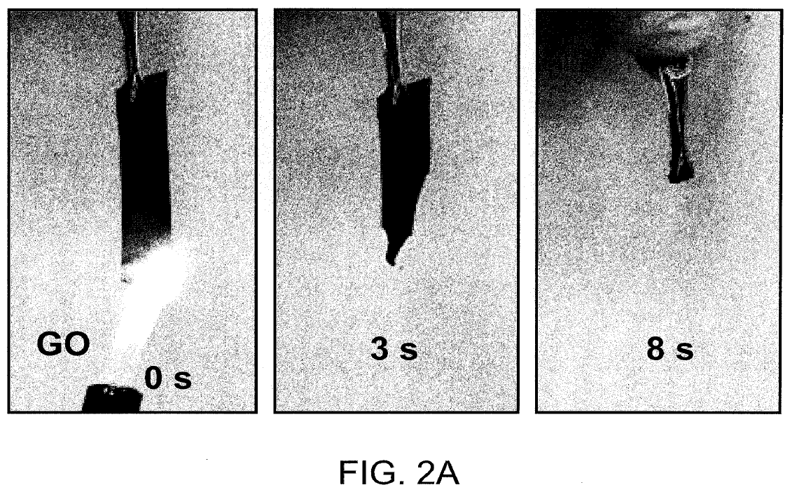

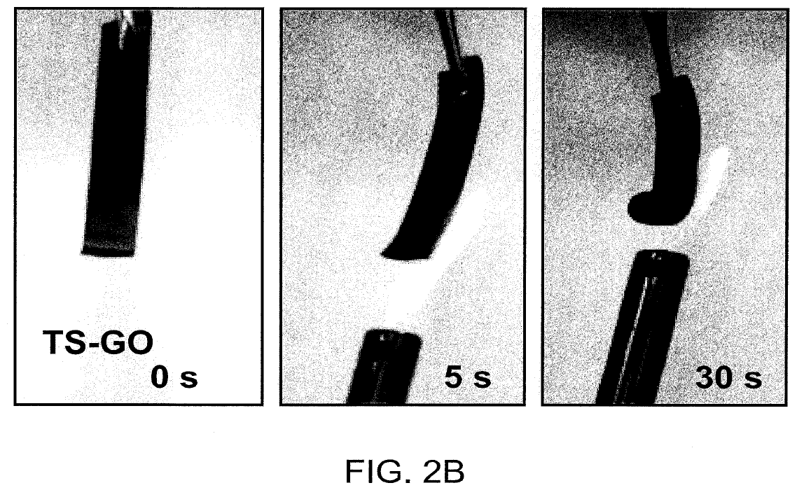

In chemical science, alkaline earth metal cation is a fairly strong Lewis acid that can form a strong bond on GO, by inducing a ring-opening reaction of the epoxide (a Lewis base) on the GO. The epoxide groups are mainly accountable for the energetic behavior of GO, hence the ring-opening reaction on epoxide group can alter the thermal decomposition kinetics. As shown in FIGS. 2(a)-(b), rapid combustion made the GO-film to vanish (or gasify) in ˜5 seconds, while no combustion (besides sintering) took place on the cl-GO film even after a time period of one minute.

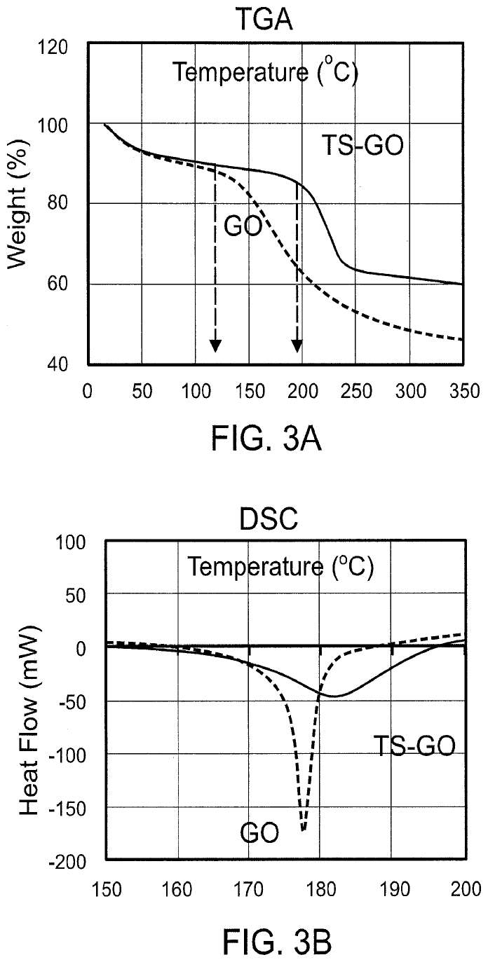

Thermo-gravimetric (TGA) data of GO and cl-GO were compared in FIG. 3(a). A minor mass-loss for both samples at 100° C. can be attributed to the desorption of physisorbed water on the samples, while the major mass-losses at 100° C.-300° C. are due to the pyrolysis of the oxygen-containing functional groups. The cl-GO didn't show a slower mass-loss starting around 200° C., while that of the GO appeared at 125° C. in a faster rate.

Differential scanning calorimetry (DSC) results of FIG. 3(b) further suggested that the GO's thermal decomposition process is much more exothermic than the cl-GO's. Intuitively, the excessive and abrupt heat-release of the GO deoxygenation reaction can trigger combustion between the GO-flakes. In contrast, the heat effect of cl-GO was much smaller. The DSC data, together with the TGA's, confirmed the Al³⁺-crosslinked GO-polymer's high thermal stability. In thermochemistry, GO's decomposition can shift to the more exothermic side due to an increased content of epoxide, and to the more endothermic due to an increased hydroxyl content. The TGA-DSC data suggest that cross-linking Al³⁺ cations to individual GO sheets triggered epoxide ring-opening reactions which decreased epoxide group's content and in turn increased the hydroxyl group content on cl-GO.

For further verifying potassium and the role of sulfur salts in the flammability of GO, a GO-film and a cl-GO film were soaked into a 1.0 wt % aqueous solution of KOH for 5 minutes, and then dried and exposed to an open-flame. Again, the GO-film was ignited instantly and disappeared quickly, while cl-GO film was not combusted at all but turned into a reduced cl-GO.

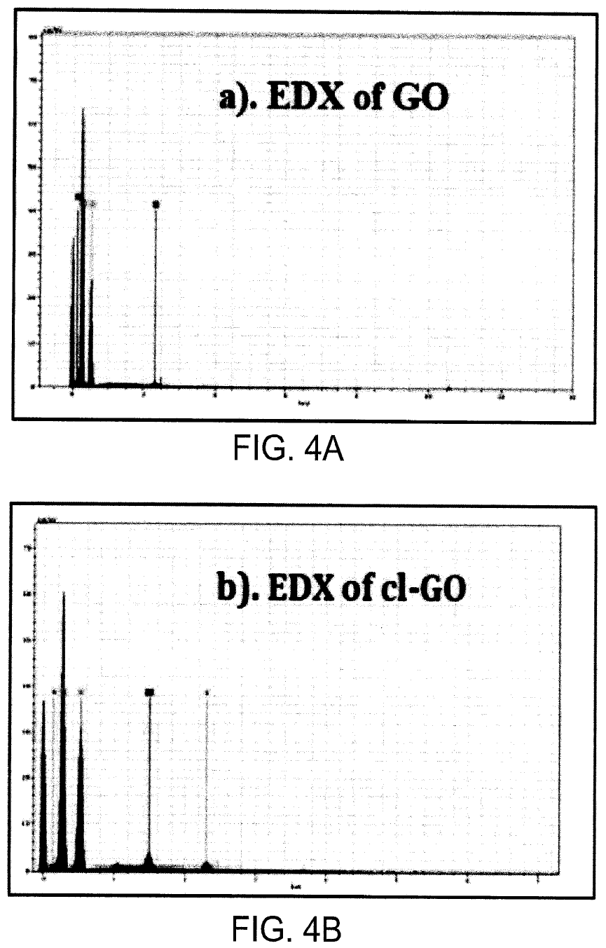

Elemental analysis revealed that GO and cl-GO films have sulphur-content of 0.17 at. % and 0.21 at. % respectively, even after being washed extensively with DI water under centrifugation. Surprisingly, as little as 0.42 at % aluminum initiated GO cross-linking within a few seconds. Elemental analysis of GO and cl-GO are provided in FIGS. 4(a) and 4(b) respectively.

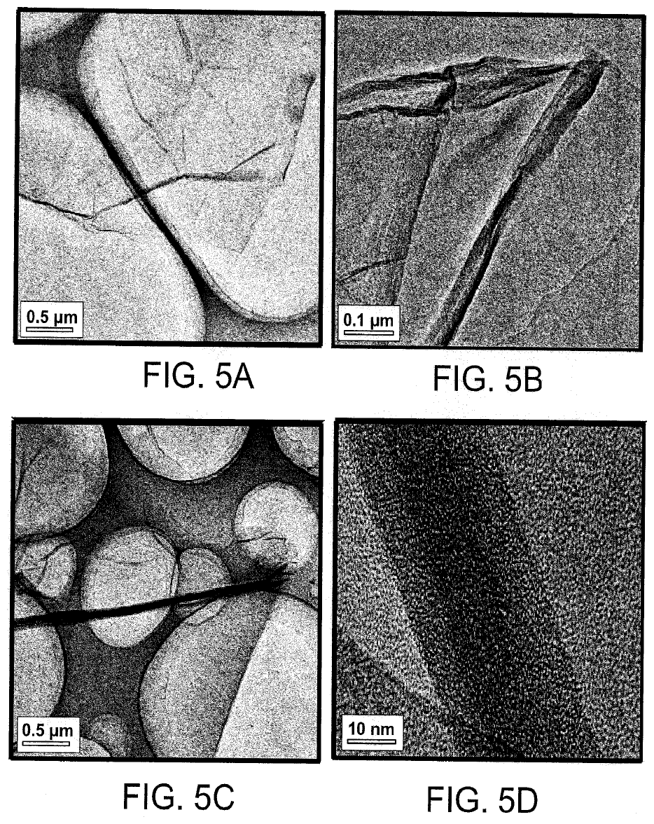

GO and cl-GO sheets were also examined by transmission electron microscopy (TEM). The TEM image in FIG. 5(a) disclosed the wrinkled nature of graphene sheets. FIG. 5(b)-5(c) show that the cl-GO sheets are linked up on the GO-edges, and the split ends of two adjacent sheets can be seen in FIG. 5(c). Under higher magnification of FIG. 5(d), a darker middle section is probably due to the existence of a higher content of Al elements.

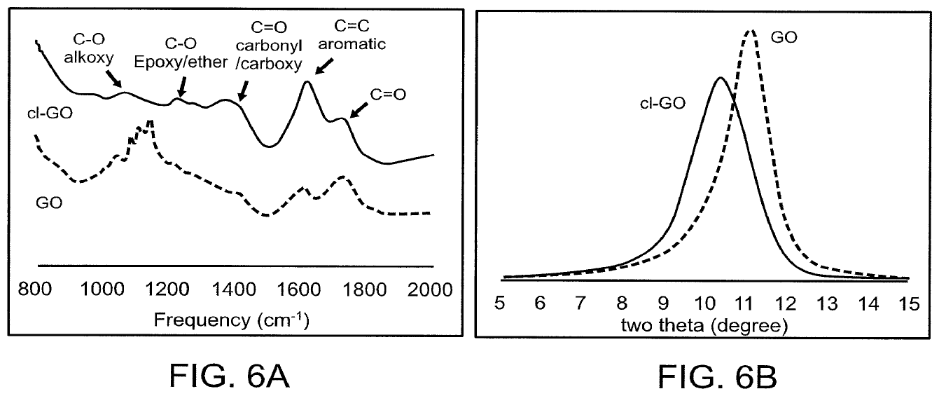

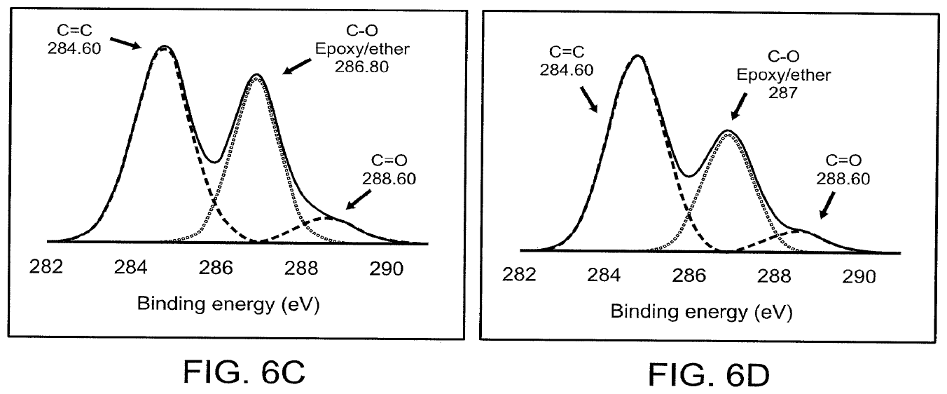

The cross-linking was further supported by the Fourier-transform infrared (FT-IR) spectra of FIG. 6(a). In comparison with the GO's typical vibrations for C═O (1733 cm⁻¹), aromatic C═C (1618 cm⁻¹), carbonyl (or carboxyl)C—O (1411 cm⁻¹), epoxy C—O (1226 cm⁻¹), and alkoxy C—O (1057-1149 cm¹), the cl-GO showed a much lower C═O's intensity. This suggests that the GO's energetic epoxy groups were reacted with the Al³⁺ cations through the ring-opening reaction, which decreased the content and intensity of the epoxy vibration. Moreover, the vibration was slightly “red”-shifted to a lower frequency probably because of the leftover ether-like functional groups that are difficult to react with the Al (III) cations.

In powder X-ray diffraction (XRD) data of FIG. 6(b), the main diffraction peak of the GO sample appeared at 2-theta of 11.4° (a lower d-space), whereas that of cl-GO at 10.39° (a higher d-space). This proves that upon cross-linking, the d-space in between the stacked cl-GO flakes was increased by the “sandwiched” Al³⁺ cations, from 0.79 nm of GO to 0.85 nm of cl-GO. This increased interlayer spacing is a strong evidence of the intercalating-cross-linking of the Al (III) cations in between the cl-GO flakes.

As provided in FIGS. 6(c)-(d), epoxide ring-opening of GO-polymerization or cross-linking is suggested by X-ray photoelectron spectroscopy (XPS) data of Cls signals of the GO and cl-GO samples. The C—O peak is mainly due to the epoxy/ether groups, and the C═O peak due to the carboxyl and ketone groups. The C—C, C—O and C═O peaks for GO ought to appear at 284.6 eV, 286.8 eV, and 288.56 eV, respectively. The C—C, C—O, and C═O peaks for cl-GO, however, were recorded at 284.6 eV, 287.0 eV, and 288.6 eV, respectively. On a much lower intensity, the C—O signal (epoxy/ether peak) of cl-GO significantly shifted upward by 0.2 eV (i.e. more stable or less energetic), which is in line with the epoxide-ring-opening reaction with Al (III) cations.

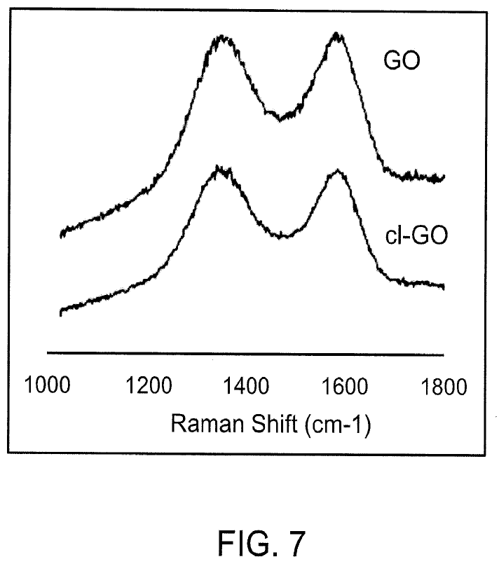

Additionally, the GO micro-Raman spectra exhibit two broad peaks at 1593 cm⁻¹ and 1355 cm⁻¹ corresponding to the G and D bands, respectively (FIG. 7). Accordingly, the cross-linking changed the D/G signal-intensity ratio, from 1.06 for GO to 1.11 for cl-GO (FIG. 7). This suggests that graphitic character was enhanced in the cl-GO by the cross-linking process. Further, the methylene blue adsorption method (MBAM) is a simple and effective method to estimate graphitic material's surface area, in which each adsorbed methylene blue's cross-sectional surface area is about 1.35 nm². Using this MBAM method, it was estimated the surface area of cl-GO and GO to be 735 and 645 m²/g respectively, and the increased 90 m²/g should be attributed to more MB molecules that can access to the expanded inter-flake space and the Al³⁺ cations.

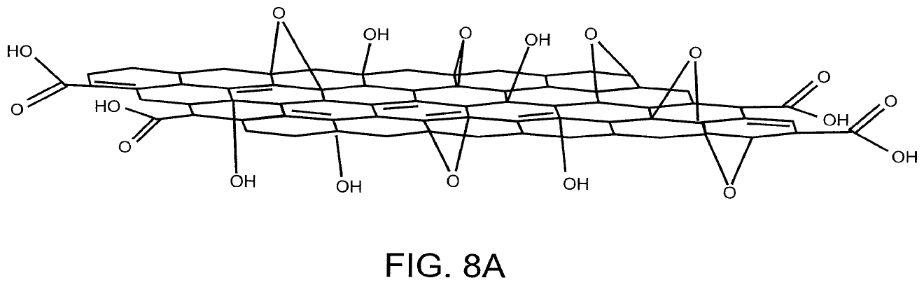

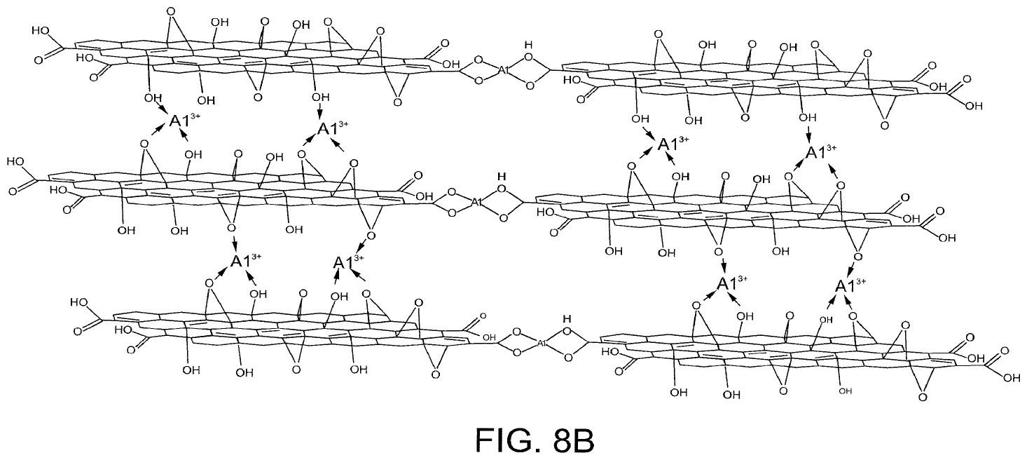

A new family of nonflammable, water-stable, flexible, lightweight and mechanically strong polymeric or cross-linked freestanding films of cl-GO has been developed out of the highly flammable, fragile and water-exfoliating GO. All experimental data consistently suggested the cl-GO that possesses a detailed microstructure as illustrated in FIG. 8. Significantly in materials chemistry, the cross-linking considerations described herein should be generally applicable to polymerizing many types of layered 2D-materials (e.g. h-BN, MoS2, clays, etc.) and even nanocrystals, for meeting new challenge in tailor-making advanced materials at low-cost and high structural precision by design and on-demand.

### Experimental Section

### A. Chemical Synthesis of GO

GO was prepared by mixing 0.5 g graphite powder (Alfa Aesar, natural, briquetting grade, −200 mesh, 99.9995% metal basis) and 0.5 g NaNO₃ (Alfa Aesar, 98+%) into 23 mL of concentrated H₂SO₄ (BDH Aristar, 95-98% min) solution, under stirring in an ice bath for 15 minutes. This was followed by adding 4 g of KMnO₄ (J. T. Baker, 99% min) gradually under stirring for another 30 minutes in an ice bath, and then transferred into a 40° C. water-bath under a stirring for about 90 minutes. The resultant paste was diluted by 50 mL deionized water, then stirred for 15 minutes, and then mixed with 6 ml of H₂O₂ (Alfa Aesar 29-32% w/w) and 50 mL DDI water. The resultant product was washed with a copious amount of DDI water and dried at 40° C. in air over 24 hours.

### B. Synthesis of Aluminum Cross-Linked Graphene Oxide (Cl-GO)

300 mg of GO was dispersed in 100 mL of DDI water under agitation. Separately, 0.2 g of Al(NO₃)₃.9H₂O (EM Science) was added to another 100 mL flask pre-filled with DDI water. The GO dispersion was gradually added into the aluminum nitrate solution, and the resultant cl-GO was stirred for 5 minutes at room temperature, then washed with copious amount of DDI water for several times.

### C. Fabrication of GO and Cl-GO Films

Equal amounts of dispersed cl-GO and GO (1 mg/mL) were used to fabricate films on various substrates such as silicon wafer, polystyrene, polyethylene terephthalate, polytetrafluoroethylene, glass slide, and plastic paraffin film. The best defect-free and durable freestanding GO and Al/GO films were formed on polystyrene substrates using drop-casting methods. After the drop casting on the substrates, films were formed from air-drying over 24 hours at room temperature.

### D. Characterization

GO and cl-GO samples were analyzed by means of PHI Versa Probe Scanning XPS Microprobe equipped with dual beam charge neutralization and a monochromatic Al K alpha source (1486 eV). Surveys were obtained with an 117 eV pass energy and 1.0 eV step size, while high resolution spectra were obtained with 23.5 eV pass energy with 0.1-0.2 eV step size, and with the time of 25 ms per step. For charge correction, 284.8 eV was used as the adventitious carbon peak position, and peak positions were determined by the curve-fitting method. TGA tests were performed on TGA Q50 V20.10 Build 36 under N2 flow, after the samples being heated from room-temperature to 350° C. at the ramping speed of 15° C./min. The DSC results were obtained in a N2-flow (20 ml/min) on Perkin Elmer Pyris Diamond Differential Scanning calorimeter for 5 mg of each sample, first being heated at 50° C. for 1 minute then heated up to 300° C. at a speed of 10° C./min. The XRD patterns were obtained from a Rigaku MiniFlex II Desktop X-ray diffractometer using monochromatized Cu-Kα radiation (λ=1.5418 Å) at 30 kV and 15 mA, in the range of 2-theta from 5° to 60° at a speed of 0.1°/min High Resolution SEM images were obtained using a FEI Nova Nanolab 200 Duo-Beam Workstation being operated on a 15 kV electron beam. In-house built Raman spectroscope equipped with 532 nm laser source at 3 mW was used to obtain the microRaman spectra. For estimating surface area using the MBAM method, the known masses of GO and cl-GO were separately soaked into an aqueous solution of metylene blue in 25 ml flasks, then stirred at 400 rpm for 48 hours, then the samples were centrifuged, and the supernatant's concentration were analyzed using UV-vis spectrophotometry (wavelength of 661 nm, U-0080D) for comparison against the original concentration and knowing the MB molecules being adsorbed. Transmission electron microscopy (TEM) images were obtained on a JOEL-2011 electron microscope operating at 200 kV equipped with an Oxford Link ISIS system for energy-dispersive X-ray spectroscopy (EDX).

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A graphene oxide composition comprising:
sheets of graphene oxide cross-linked with one another via metal cations in an oxidation state of at least 3⁺.

2. The graphene oxide composition of claim 1, wherein the metal cations are selected from the group consisting of aluminum cations, transition metal cations, rare earth cations and combinations thereof.

3. The graphene oxide composition of claim 1, wherein the oxidation state is from 4⁺ to 6⁺.

4. The graphene oxide composition of claim 1, wherein faces and/or edges of the graphene oxide sheets are cross-linked by the metal cations.

5. The graphene oxide composition of claim 1, wherein one or more of the metal cations are covalently bonded to the graphene oxide sheets.

6. The graphene oxide composition of claim 1, wherein the sheets of cross-linked graphene oxide are stable under ambient atmospheric conditions

7. The graphene oxide composition of claim 1, wherein the sheets of cross-linked graphene oxide are inflammable under ambient atmospheric conditions upon exposure to an open flame.

8. The graphene oxide composition of claim 1, wherein the metal cations are aluminum cations.

9. The graphene oxide composition of claim 1, wherein the cross-linked sheets of graphene oxide form a freestanding film or membrane.

10. A composite composition comprising:
a substrate; and
a graphene oxide film positioned over the substrate, the graphene oxide film comprising sheets of graphene oxide cross-linked with one another via metal cations in an oxidation state of at least 3⁺.

11. The composite composition of claim 10, wherein faces and/or edges of the graphene oxide sheets are cross-linked by the metal cations.

12. The composite composition of claim 10, wherein the sheets of cross-linked graphene oxide are inflammable under ambient atmospheric conditions upon exposure to an open flame.

13. The composite composition of claim 10, wherein the metal cations are selected from the group consisting of aluminum cations, transition metal cations, rare earth cations and combinations thereof.

14. A method of making a graphene oxide composition comprising:
providing a mixture of graphene oxide sheets and metal cations in polar continuous phase; and
cross-linking the graphene oxide sheets with the metal cations, wherein the metal cations are in an oxidation state of at least 3⁺.

15. The method of claim 14, faces and/or edges of the graphene oxide sheets are cross-linked by the metal cations.

16. The method of claim 14, wherein one or more of the metal cations are covalently bonded to the graphene oxide sheets.

17. The method of claim 14, wherein the metal cations are provided as a salt in the mixture.

18. The method of claim 14, wherein the sheets of cross-linked graphene oxide are stable under ambient atmospheric conditions.

19. The method of claim 14, wherein the sheets of cross-linked graphene oxide are inflammable under ambient atmospheric conditions.

20. The method of claim 14, wherein the metal cations are selected from the group consisting of aluminum cations, transition metal cations, rare earth cations and combinations thereof.

21. The method of claim 14, wherein the polar continuous phase is water or aqueous-based solvent.

22. The method of claim 14, wherein the sheets of graphene oxide are added to a salt solution of the metal cations.

23. The method of claim 14 further comprising washing the cross-linked graphene oxide sheets with water or aqueous based solution.
